(19) United States
(12) Patent Application Publication
(10) Pub. No.: US 2024/0428310 A1
(43) Pub. Date: Dec. 26, 2024

(54) TRAINED MODELS FOR PREDICTING TIMES FOR COMPLETION OF TASKS FOR AN ORDER PLACED WITH AN ONLINE SYSTEM AND DETERMINING REMEDIAL ACTIONS

(71) Applicant: Maplebear Inc. (dba Instacart), San Francisco, CA (US)

(72) Inventors: Dustin Neray, Toronto (CA); Licheng Yin, Burlingame, CA (US); George Zeng, San Francisco, CA (US); Siddarth Kalra, Toronto (CA); Levon Dolbakian, Berkeley, CA (US); Amos Too, Brooklyn, NY (US); Jaclyn Tandler, San Francisco, CA (US)

(21) Appl. No.: 18/214,316

(22) Filed: Jun. 26, 2023

(51) Int. Cl. G06Q 30/0601

(52) U.S. Cl. CPC G06Q 30/0613

(57) ABSTRACT

Embodiments are related to automatic prediction of times for completion of tasks for an order by a picker associated with an online system and determination of an appropriate intervention for the picker. The online system applies a computer model to predict a plurality of times for completion of a plurality of tasks associated with the first order. The online system determines that the picker who accepted the first order did not complete a task of the plurality of tasks at a predicted time of the plurality of times increased by a threshold time. The online system determines an intervention associated with the picker, based in part on the determination that the picker did not complete the task. The online system causes a device of the picker to display a message that corresponds to the determined intervention.

### BACKGROUND

Online systems, such as online concierge systems, typically expect that, after a picker (i.e., shopper) accepts an order (i.e., batch), that the picker travels to a store (i.e., warehouse) and pick items associated with the accepted order. If the picker who accepted the order does not perform these tasks, or does not perform them quickly enough, this may lead to a late delivery for the order and a bad experience for a customer of an online concierge system who placed the order. Conventional online concierge systems provide each picker with a fixed amount of time to complete stages of an order (e.g., start moving, get to a store, start picking items, perform checkout, etc.), before the picker is warned and then removed from the order. In particular, a conventional online concierge system typically monitors a picker's current location and compares it to an original location of the picker (i.e., a location from where the picker accepted an order). The conventional online concierge system typically defines static time thresholds (which may differ depending on whether or not the picker started at a store or away from the store) for sending warning messages to the picker. In the case when a picker accepted an order away from a store and did not have any progress in completing the order in response to multiple warning messages, the conventional online concierge system simply removes the picker from the order. However, these fixed rules and static threshold times are often inefficient and inflexible, and do not consider effects they have in completion of orders.

### SUMMARY

Embodiments of the present disclosure are directed to utilizing a trained computer model (e.g., machine-learning model) to automatically predict a future time for completion of each task for an order placed with an online concierge system. The online concierge system compares a current state of a picker who accepted the order with a predicted schedule in completing the order. Based on the comparison, the online concierge system automatically determines appropriate remedial actions (i.e., interventions) for the picker when the picker is behind the projected schedule, while considering an effect of each remedial action on a completion of the order.

In accordance with one or more aspects of the disclosure, an online concierge system receives, from a user of the online concierge system, a first order placed with the online concierge system. The online concierge system accesses a computer model of the online concierge system trained to predict a time for completion of each task associated with an order placed with the online concierge system. The online concierge system applies the computer model to predict a plurality of times for completion of a plurality of tasks associated with the first order. The online concierge system determines that a picker associated with the online concierge system who accepted the first order did not complete a task of the plurality of tasks at a predicted time of the plurality of times increased by a threshold time. The online concierge system determines an intervention associated with the picker, based in part on the determination that the picker did not complete the task. The online concierge system causes a device of the picker to display a message that corresponds to the determined intervention.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3A illustrates example warning interventions for a picker associated with an online concierge system who accepted an order and is not located at a warehouse associated with the order, in accordance with one or more embodiments.

FIG. 3B illustrates example warning interventions for a picker associated with an online concierge system who accepted an order and is located at a warehouse associated with the order, in accordance with one or more embodiments.

FIG. 4 illustrates example removal interventions applied to a picker associated with an online concierge system who accepted an order, in accordance with one or more embodiments.

FIG. 5 is a flowchart of a method of automatic prediction of times for completion of tasks by a picker associated with an online concierge system for an order placed with the online concierge system and determination of appropriate interventions for the picker, in accordance with one or more embodiments.

### DETAILED DESCRIPTION

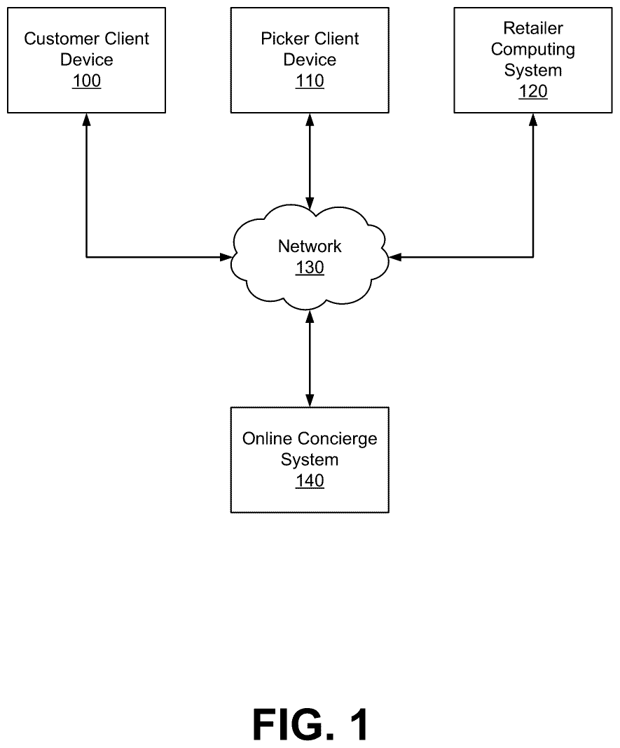

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item”, as used herein, means a good or product that can be provided to the customer through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer, so that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi-or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provide portions of the payment from the customer to the picker and the retailer.

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140.

The online concierge system 140 makes orders (i.e., batches) available to pickers associated with the online concierge system 140, who can accept the orders and then fulfill the orders by traveling to a warehouse (or grocery store), picking the ordered items, and delivering the order to a customer of the online concierge system 140 who placed the order. If a picker associated with the online concierge system 140 accepts an order but does not begin fulfilling the order fast enough, the customer's experience may suffer. To avoid this, the online concierge system 140 presented herein utilizes a trained machine-learning computer model to predict one or more future times by which certain tasks (or “milestones”) in an order fulfillment process should have been completed. Additionally, the online concierge system 140 determines a picker's actual progress in completing the order. Based on the predicted future times for completion of the tasks and the picker's actual progress, the online concierge system 140 can determine whether the picker is behind a schedule for completion of the order.

If the picker is behind completion of a task (or “milestone) by a threshold time, the online concierge system 140 determines an appropriate remedial action (i.e., intervention) for the picker. An example intervention is sending a warning message to the picker when the picker surpasses a predicted time for a milestone transition in the order fulfillment process by a threshold time. Another example intervention is a removal of the picker from the order when the picker exceeded an expected start time of the order fulfillment process by a threshold time. In one or more embodiments, the online concierge system 140 determines an appropriate intervention by utilizing a second trained machine-learning computer model that predicts an effect on a metric for different candidate interventions. The metric for each candidate intervention may be an amount of time required for the picker to complete the order when that candidate intervention is used.

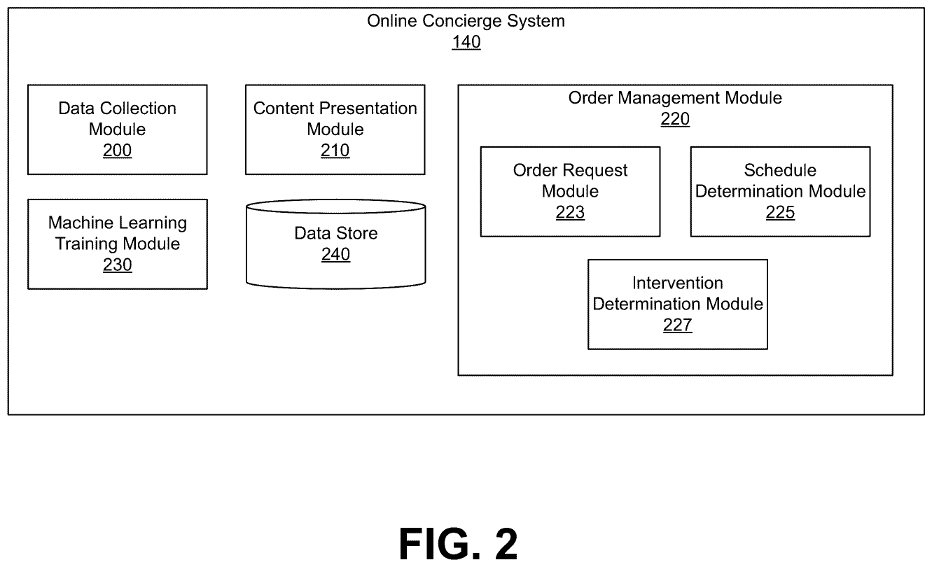

The online concierge system 140 deploys the computer model to predict a state of a picker at a particular future time in relation to an order fulfillment process. After that, the online concierge system 140 compares a picker's actual state to the predicted state and determines if the picker is “too” far behind the schedule (e.g., more than a threshold amount of time behind the schedule). When the online concierge system 140 determines that the picker is “too” far behind the schedule, the online concierge system 140 may determine to “nudge” the picker in order to encourage the picker to start fulfilling the order. Alternatively or additionally, when the online concierge system 140 determines that the picker is “too” far behind the schedule, the online concierge system 140 may remove the picker from the order and allow another picker associated with the online concierge system 140 to accept the order. Thus, the goal of the trained computer model deployed by the online concierge system 140 is to automatically determine if a picker is progressing slowly against their order and is behind the schedule in fulfilling the order. The computer model is trained to determine where the picker should be at a current point in time and triggers one or more remedial actions (i.e., interventions) for the picker if the picker is behind the schedule in fulfilling the order. More details about this approach are described in relation to FIGS. 2 through 5.

FIG. 2 illustrates an example system architecture for the online concierge system 140, in accordance with some embodiments. The system architecture illustrated in FIG. 2 includes a data collection module 200, a content presentation module 210, an order management module 220, a machine-learning training module 230, and a data store 240. The order management module 220 includes an order request module 223, a schedule determination module 225, and an intervention determination module 227. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits an ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine-learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine-learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of the order. In some embodiments, the order management module 220 computes an estimated time of arrival of the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The order request module 223 of the order management module 220 may receive, from a customer of the online concierge system 140, an order placed with the online concierge system 140. The customer may place the order via the customer client device 100, and the order may be provided to the order request module 223 via the network 130. The order request module 223 may provide details about the order to one or more other components of the order management module 220, such as to the schedule determination module 225. In one or more embodiments, the order request module 223 extracts (e.g., in communication with one or more other modules of the online concierge system 140, such as the data store 240) features of the placed order and provide the features of the order to, e.g., a computer model deployed by the schedule determination module 225. The features of the order being input into the computer model may include: a location of a warehouse associated with the order, information about a busyness of the warehouse, information about a current marketplace state (e.g., time of day, other orders, etc.), information about congestion of a parking lot of the warehouse, a number of items in the order, a quantity of each item in the order, etc. The order request module 223 may also provide information about the order available to a plurality of pickers associated with the online concierge system 140. At a certain time instant (which is considered to be a starting point in an order fulfillment process), a picker of the plurality of pickers accepts the order.

The schedule determination module 225 may determine an actual progress of the picker who accepted the order in completing the order relative to a predicted progress (i.e., a predicted schedule of tasks that need to be completed by the picker). The schedule determination module 225 may apply a computer model trained to predict a future time for completion of each task associated with the placed order. Tasks associated with the order can include, e.g., start heading to a warehouse (or store) associated with the order, heading to the warehouse in a correct direction, start picking items when arrived at the warehouse, checking out the order at the warehouse, start heading to a location of a customer who placed the order, delivering the order to the customer, etc. The computer model deployed by the schedule determination module 225 may run a machine-learning algorithm (e.g., machine-learning regression algorithm) to predict the future time for completion of each task associated with the placed order. A set of parameters for the trained computer model may be stored on one or more non-transitory computer-readable media of the schedule determination module 225. Alternatively, the set of parameters for the computer model may be stored on one or more non-transitory computer-readable media of the data store 240.

As aforementioned, some inputs to the computer model deployed by the schedule determination module 225 may include one or more features of the order, such as a location of a warehouse associated with the order, information about a busyness of the warehouse, information about a current marketplace state (e.g., time of day, other orders, etc.), information about congestion of a parking lot of the warehouse, a number of items in the order, a quantity of each item in the order, or some other information. Additional inputs to the computer model may include one or more features of the picker who accepted the order (e.g., as available from the data store 240). The one or more features of the picker that can be input to the computer model may include at least one of: information about a picker's location (e.g., a physical current location, location history, progress on current order, driving state, arrival state, picking state, checkout state, current picking step, etc.), information about historic drive times of the picker to the warehouse, information about traffic signals from the picker's location to the warehouse, picker's specific attributes, information about one or more orders completed by the picker (e.g., a number of items in an order, a quantity of each item in the order, a monetary value of the order, location of the items in the warehouse, etc.), and information about the picker's historical picking speed versus items in the order.

The computer model deployed by the schedule determination module 225 may output a plurality of predicted future times for completion of a plurality of tasks (or “milestones”) associated with the order. Each predicted future time defines a predicted state of the picker at that future time. The schedule determination module 225 may further receive (e.g., from the picker client device 110 via the network 130) information about a current state of the picker in fulfilling the order. The schedule determination module 225 may then compare the current state of the picker with the predicted state of the picker to determine whether the picker has completed each task at the predicted future time. In other words, the schedule determination module 225 determines if the picker is behind the schedule by computing (e.g., via the computer model) where the picker should be at a particular time and compares that information with the actual state of the picker. For example, when the order is accepted, the schedule determination module 225 computes (e.g., via the computer model) when the picker should achieve certain milestones (i.e., complete tasks), such as heading to the warehouse, arriving at the warehouse, start picking items, checking out, and arriving at the customer's location for delivery. When the schedule determination module 225 determines that the picker did not complete the task at the predicted future time increased by a threshold time, the online concierge system 140 becomes aware that either the picker has encountered certain issues or is deliberately not making progress toward completion of the order. In either case, the online concierge system 140 determines (e.g., via the intervention determination module 227) what would be an appropriate remedial action (i.e., intervention) for the picker in order to complete the order as fast as possible.

In one or more embodiments, each threshold time that is used by the schedule determination module 225 to determine how “far” behind the schedule the picker is, can be determined as static amounts of time (e.g., a fixed number of seconds for each task of the order). Alternatively, the threshold times may be variable. In some embodiments, the threshold times vary based on a location of the picker relative to a location of the warehouse. For example, if the picker is closer to the warehouse, a threshold time for a corresponding task of the order (e.g., start picking items) may be lower, and vice-versa. In some other embodiments, the threshold time may be fully dynamic and controlled by a machine-learning algorithm (e.g., run by the computer model deployed by the schedule determination module 225) based on prior data associated with the picker (e.g., information about any prior removal of the picker from an order, feedback information from the picker in response to prior warning interventions, etc.).

After the schedule determination module 225 determines that the picker did not complete a task (or “milestone”) at a predicted future time (e.g., as predicted by the computer model) increased by a threshold time, the intervention determination module 227 determines an appropriate intervention for the picker. The intervention determination module 227 may determine the appropriate intervention for the picker based in part on a specific task that the picker did not complete by the predicted future time increased by the threshold time. For example, the intervention determination module 227 may decide on what the appropriate intervention will be after the schedule determination module 225 determines that a projected picking start time has exceeded a predicted picking start time (e.g., as predicted by the computer model) by a threshold time. Information that the intervention determination module 227 may consider for determination of the appropriate intervention may include: information on should the picker have left their acceptance location already, information on whether the picker is heading in the right direction toward a warehouse, information on whether the picker is delayed based on a busyness of the warehouse, some other information about the picker, or some combination thereof.

The intervention determination module 227 may determine that the appropriate intervention is a warning for the picker, if the projected state of the picker is a first threshold time behind a predicted future time for completion of a specific task of an order. The intervention determination module 227 may determine that the appropriate intervention is a removal of the picker from an order, if the projected state of the picker is a second threshold time behind the predicted future time for completion of the specific task, where the second threshold time is longer than the first threshold time. The intervention determination module 227 may determine the appropriate intervention based on a progress of the picker in completing the order, an availability of other pickers associated with the online concierge system 140 to accept the order, estimated time to accept (TTA) the order by another picker, some other information associated with a supply of the online concierge system 140, or come combination thereof.

In some embodiments, the intervention determination module 227 applies a second computer model trained to predict an effect of each candidate intervention of a plurality of candidate interventions on a metric associated with an order placed with the online concierge system 140. The metric associated with the order may be a time for completion a specific task (i.e., milestone) of the order if a particular candidate intervention is applied (i.e., picker's retention), a time for completion of all tasks in the order if a particular candidate intervention is applied, some other metric associated with an order fulfillment process, or some combination thereof. The second model may be trained (e.g., via the machine-learning training module 230) to determine appropriate interventions for the picker depending on one or more features of the picker. The second model deployed by the intervention determination module 227 may be trained to optimize for a customer's experience and prevent the order from being late while maximizing a picker's retention.

Certain information associated with a picker and/or a warehouse associated with the order may be input into the second computer model. For example, inputs to the second computer model may include at least one of: one or more picker's attributes, information about picker's behavior, a tenure of the picker, information about a picker's location (e.g., a physical current location, location history, progress on current order, driving state, arrival state, picking state, checkout state, current picking step, etc.), information about historic drive times of the picker to the warehouse, information about traffic signals from the picker's location to the warehouse, information about a busyness of the warehouse, information about a current marketplace state (e.g., time of day, other orders, etc.), information about congestion of a parking lot of the warehouse, specific attributes of the picker, information about one or more orders completed by the picker (e.g., a number of items in an order, a quantity of each item in the order, a monetary value of the order, location of the items in the warehouse, etc.), and information about the picker's historical picking speed versus items in the order.

An output of the second computer model may be a signal for the intervention determination module 227 that triggers an appropriate intervention for the picker. For example, a first signal output by the second computer model may trigger the intervention determination module 227 to generate a first warning intervention that nudges the picker to complete a specific task of an order; a second signal output by the second computer model may trigger the intervention determination module 227 to generate a second warning intervention that informs the picker about a possible removal from the order; and a third signal output by the second computer model may trigger the intervention determination module 227 to generate a message informing the picker of being removed from the order.

In some embodiments, the second computer model deployed by the intervention determination module 227 is trained to predict the metric (e.g., picker's retention, order completion, etc.) based on threshold times (e.g., the first and second threshold times) before an intervention is taken. After that, the second computer model may further determine the threshold times based on the effect of a particular intervention on the predicted metric. For determining the remedial action of removing the picker from the order, the second computer model may utilize some additional information input into the second computer model, such as information about a progress of the picker in completing the order, information about availability of other pickers to accept the order, and a predicted TTA if the order is reassigned to another picker. For example, the second computer model may be trained to not remove the picker from the order if the picker is behind by a time period that is less than a predicted TTA if the order was made available to other pickers.

The content presentation module 210 may cause a device of a picker (e.g., the picker client device 110) to display a message that corresponds to an intervention determined and generated by the intervention determination module 227. Responsive to a determination by the intervention determination module 227 that the intervention is a warning, the content presentation module 210 may cause the device of the picker to display a corresponding warning message. And responsive to a determination that the intervention is removing the picker from the order, the content presentation module 210 may cause the device of the picker to display a message informing the picker of being removed from the order.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include customer data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

The machine-learning training module 230 trains a first computer model that is deployed by the schedule determination module 225 to predict a future time for completion of each task associated with an order placed with the online concierge system 140. To train the first computer model, the machine-learning training module 230 may utilize training data (e.g., from the data store 240) with information about times when certain tasks are completed for a set of orders. The machine-learning training module 230 may further utilize a production model error to retrain (or, more generally, “update”) the first computer model. For example, the production model error used for retraining the first computer model may include information about any false positive occurrence, i.e., an occurrence of triggering an intervention for a picker although the picker has already completed a corresponding task associated with an order.

The machine-learning training module 230 trains a second computer model that is deployed by the intervention determination module 227 to predict an effect of each candidate intervention of a plurality of candidate interventions on a completion of an order placed with the online concierge system 140. The machine-learning training module 230 may utilize training data (e.g., from the data store 240) with information about effects of different interventions applied to a particular picker or to a set of pickers over a defined period of time to train the second model. The machine-learning training module 230 may further retrain (or, more generally, “update”) the second computer model based on feedback information from the picker in relation to one or more recently applied interventions.

The data store 240 stores data used by the online concierge system 140. For example, the data store 240 stores customer data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

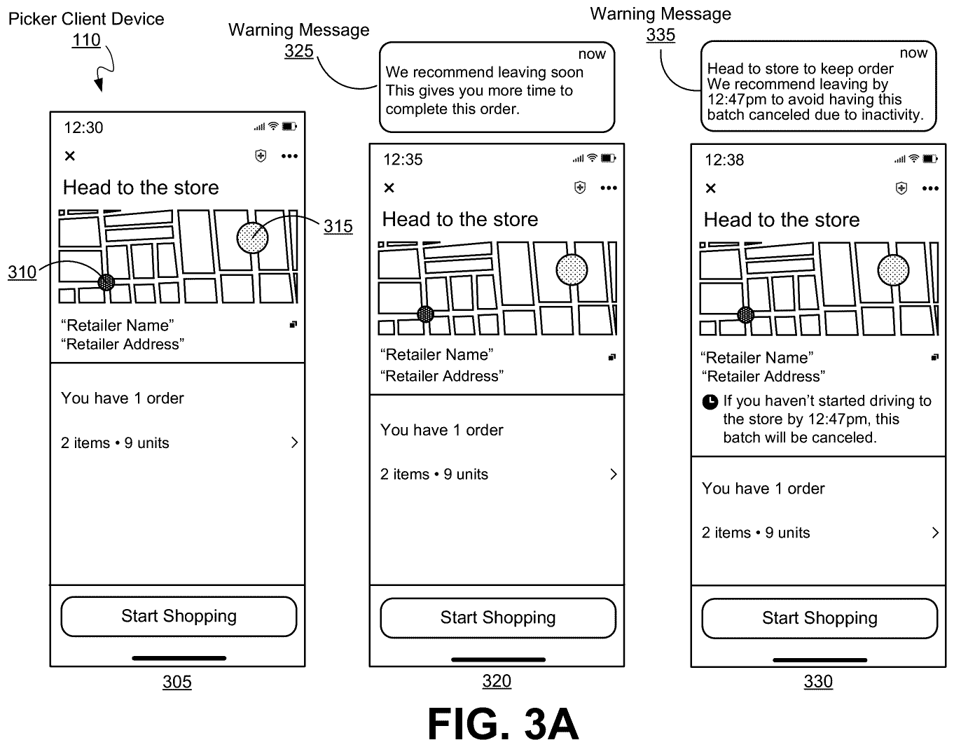

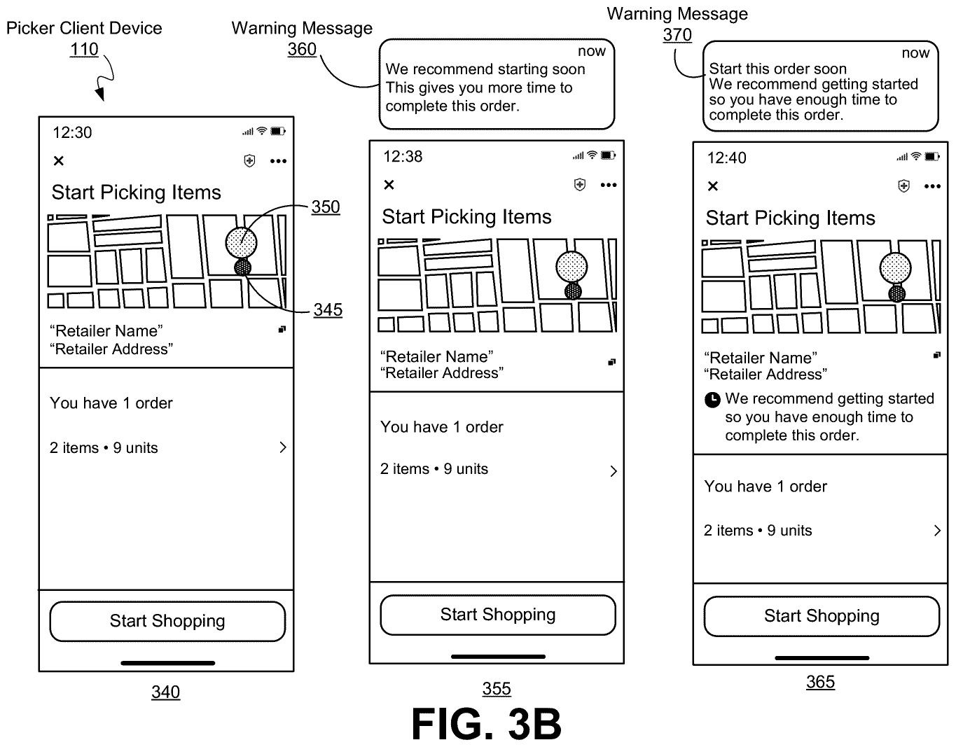

FIG. 3A illustrates example warning interventions for a picker associated with the online concierge system 140 who accepted an order and is not located at a store (i.e., warehouse) associated with the order, in accordance with one or more embodiments. During a first time period (e.g., from 0-4 minutes from an acceptance of the order), the picker client device 110 displays a user interface 305 with confirmation that the picker accepted an order, a picker's current location 310, a location 315 of the store associated with the order, and a current task for the picker (e.g., “Head to the store”). The user interface 305 may be displayed starting at a start time that corresponds to a time when the picker accepted the order. After a first threshold time of inactivity of the picker (e.g., 5 minutes from the start time), the schedule determination module 225 may determine that the picker did not finish the current task, and the intervention determination module 227 may determine that a warning intervention is suitable for the picker. Then, during a second time period (e.g., during the 5^{th} minute from the start time), the content presentation module 210 causes the picker client device 110 to display a user interface 320 with a warning message 325 for the picker. After a second threshold time of inactivity of the picker (e.g., 8 minutes from the start time), the schedule determination module 225 may determine that the picker still did not finish the current task, and the intervention determination module 227 may determine that a second warning intervention is suitable for the picker. Then, during a third time period (e.g., during the 8^{th} minute from the start time), the content presentation module 210 causes the picker client device 110 to display a user interface 330 with a warning message 335 that warns the picker about a potential removal of the picker from the order. A future time (e.g., 12:47 pm) specified in the warning message 335 for completion of the current task (“Head to the store”) may be determined by the computer model deployed by the schedule determination module 225.

FIG. 3B illustrates example warning interventions for a picker associated with the online concierge system 140 who accepted an order and is located at a store (i.e., warehouse) associated with the order, in accordance with one or more embodiments. During a first time period (e.g., from 0-7 minutes from an acceptance of the order), the picker client device 110 displays a user interface 340 with confirmation that the picker accepted an order, a current picker's 345, a location 350 of the store associated with the order, and a current task for the picker (e.g., “Start Picking Items”). The user interface 340 may be displayed starting at a start time that corresponds to a time when the picker accepted the order. After a first threshold time of inactivity of the picker (e.g., 8 minutes from the start time), the schedule determination module 225 may determine that the picker did not finish the current task, and the intervention determination module 227 may determine that a warning intervention is suitable for the picker. Then, during a second time period (e.g., during the 8^{th} minute from the start time), the content presentation module 210 causes the picker client device 110 to display a user interface 355 with a warning message 360 for the picker. After a second threshold time of inactivity of the picker (e.g., 10 minutes from the start time), the schedule determination module 225 may determine that the picker still did not finish the current task, and the intervention determination module 227 may determine that a second warning intervention is suitable for the picker. Then, during a third time period (e.g., during the 10^{th} minute from the start time), the content presentation module 210 causes the picker client device 110 to display a user interface 365 with a warning message 370 for the picker.

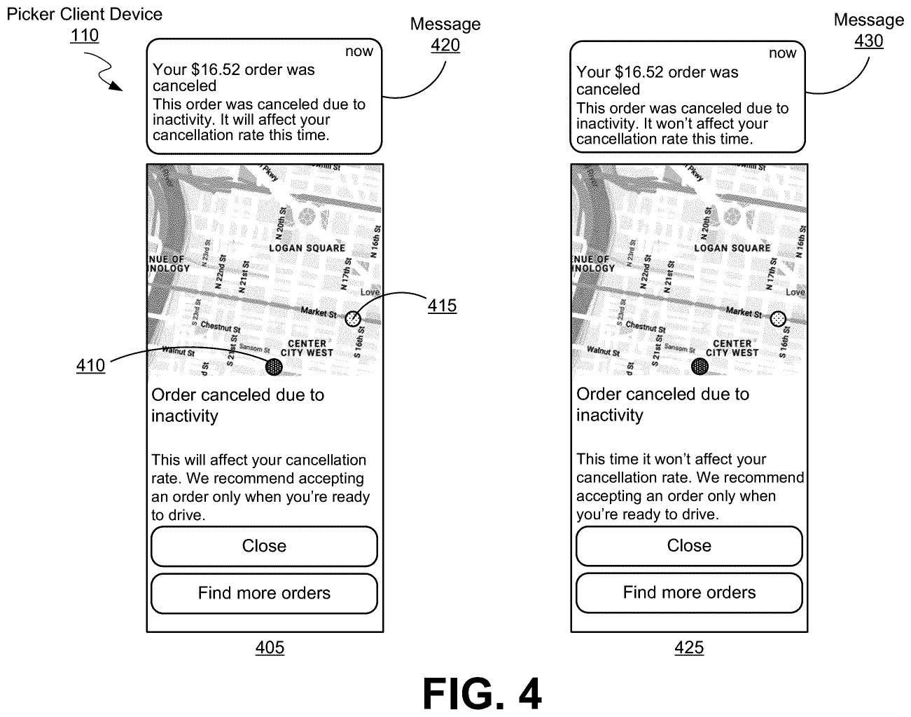

FIG. 4 illustrates example removal interventions applied to a picker associated with the online concierge system 140 who accepted an order, in accordance with one or more embodiments. In one or more embodiments, the picker client device 110 displays a user interface 405 with a current picker's location 410 and a location 415 of a warehouse (i.e., store) associated with the order. Due to an inactivity of the picker, the schedule determination module 225 determines that the picker did not finish a current order (e.g., “Head to the store”) by a predicted future time (e.g., as predicted by the computer model deployed by the schedule determination module 225) increased by a threshold time (e.g., total of 17 minutes from a start time when the order has been accepted). In such a case, the intervention determination module 227 determines that a removal intervention is suitable. In response to receiving a trigger signal from the intervention determination module 227, the content presentation module 210 causes the picker client device 110 to display a message 420 informing the picker that the picker is being removed from the order. The message 420 may further inform the picker that the removal intervention will affect the picker's cancellation rate. Note that the message 420 is not a first intervention message displayed to the picker but was rather preceded by one or more prior warning messages (e.g., the warning messages 325 and 335 in FIG. 3A). In one or more other embodiments, the picker client device 110 displays a user interface 425 with a message 430 informing the picker that the picker is being removed from the order and that the removal intervention will not affect the picker's cancellation rate.

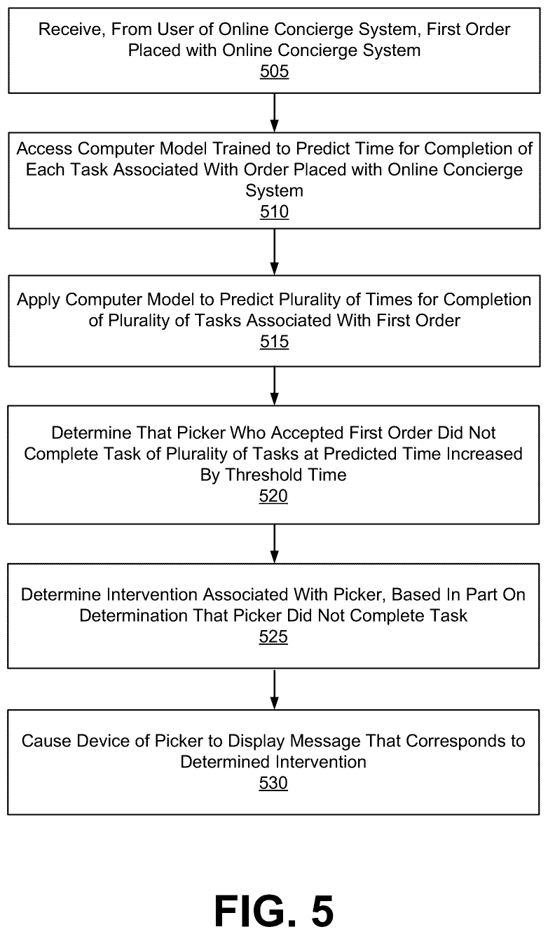

FIG. 5 is a flowchart of a method of using a computer model to predict times for completion of order tasks by a picker associated with an online concierge system and determination of appropriate interventions for the picker, in accordance with one or more embodiments. Alternative embodiments may include more, fewer, or different steps from those illustrated in FIG. 5, and the steps may be performed in a different order from that illustrated in FIG. 5. These steps may be performed by an online concierge system (e.g., the online concierge system 140). Additionally, each of these steps may be performed automatically by the online concierge system without human intervention.

The online concierge system 140 receives 505 (e.g., via the order request module 221), from a user of the online concierge system 140, a first order placed with the online concierge system 140. The online concierge system 140 accesses 510 a computer model of the online concierge system 140 (e.g., via the schedule determination module 225) trained to predict a time for completion of each task associated with an order placed with the online concierge system 140.

The online concierge system 140 applies 515 (e.g., via the schedule determination module 225) the computer model to predict a plurality of times for completion of a plurality of tasks associated with the first order. The online concierge system 140 may input, into the computer model, information associated with at least one of the picker and the first order to predict the plurality of times for completion of the plurality of tasks associated with the first order. The information input into the computer model may comprise at least one of: a location of the picker, one or more features of the picker, a location of a warehouse associated with the first order, and one or more features of the warehouse.

The online concierge system 140 determines 520 (e.g., via the schedule determination module 225) that a picker associated with the online concierge system 140 who accepted the first order did not complete a task of the plurality of tasks at a predicted time of the plurality of times increased by a threshold time. The online concierge system 140 may compare (e.g., via the schedule determination module 225) a current state of the picker in a process of completing the plurality of tasks at the predicted time increased by the threshold time with a predicted state of the picker at the predicted time. Based on the comparison, the online concierge system 140 may then determine (e.g., via the schedule determination module 225) that picker did not complete the task at the predicted time increased by the threshold time. The online concierge system 140 may determine (e.g., via the schedule determination module 225) the threshold time based on a current location of the picker relative to a location of a warehouse associated with the first order. Alternatively, the online concierge system 140 may determine (e.g., via the schedule determination module 225) the threshold time by applying a machine-learning algorithm on data associated with the picker.

The online concierge system 140 determines 525 (e.g., via the intervention determination module 227) an intervention associated with the picker, based in part on the determination that the picker did not complete the task. The online concierge system 140 may determine (e.g., via the intervention determination module 227) that the intervention is a warning for the picker. Alternatively, the online concierge system 140 may determine (e.g., via the intervention determination module 227) that the intervention is a removal of the picker from the first order. The online concierge system 140 may determine (e.g., via the intervention determination module 227) the intervention further based on at least one of: a progress of the picker in completing the first order, an availability of one or more pickers associated with the online concierge system 140 to accept the first order, and a predicted amount of time for another picker of a plurality of pickers associated with the online concierge system 140 to accept the first order once the first order is made available to the plurality of pickers.

In some embodiments, the online concierge system 140 accesses a second computer model (e.g., via the intervention determination module 227) trained to predict an effect of each candidate intervention of a plurality of candidate interventions on a completion of the plurality of tasks. The online concierge system 140 may apply the second computer model (e.g., via the intervention determination module 227) to determine the intervention from the plurality of candidate interventions. The online concierge system 140 may input, into the second computer model (e.g., via the intervention determination module 227), information associated with at least one of the picker and a warehouse associated with the first order to determine the intervention from the plurality of candidate interventions.

The online concierge system 140 causes 530 (e.g., via the content presentation module 210) a device of the picker (e.g., the picker client device 110) to display a message that corresponds to the determined intervention. Responsive to the determination that the intervention is the warning, the online concierge system 140 may cause (e.g., via the content presentation module 210) the device of the picker to display a warning message. Responsive to the determination that the intervention is the removal, the online concierge system 140 may cause (e.g., via the content presentation module 210) the device of the picker to display a message informing the picker of being removed from the first order.

Embodiments of the present disclosure are directed to automatic prediction of future times for completion of tasks by a picker associated with the online concierge system 140 for an order placed with the online concierge system 140 and determination of appropriate remedial actions (or interventions) for the picker. The online concierge system 140 uses a machine-learning computer model to predict future times for completion of tasks of the order and compares a picker's current state to the predicted future times. When the online concierge system 140 determines that the picker is behind the schedule by more than a threshold time, the online concierge system 140 may utilize another machine-learning computer model to determine an appropriate intervention for the picker, where the other machine-learning computer model is trained to predict effects of different interventions.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
receiving, from a user of an online concierge system, a first order placed with the online concierge system;
accessing a computer model of the online concierge system trained to predict a time for completion of each task associated with an order placed with the online concierge system;
applying the computer model to predict a plurality of times for completion of a plurality of tasks associated with the first order;
determining that a picker associated with the online concierge system who accepted the first order did not complete a task of the plurality of tasks at a predicted time of the plurality of times increased by a threshold time;
determining an intervention associated with the picker, based in part on the determination that the picker did not complete the task; and
causing a device of the picker to display a message that corresponds to the determined intervention.

2. The method of claim 1, wherein applying the computer model comprises:
inputting, into the computer model, information associated with at least one of the picker and the first order to predict the plurality of times for completion of the plurality of tasks associated with the first order.

3. The method of claim 2, wherein inputting the information into the computer model comprises inputting at least one of: a location of the picker, one or more features of the picker, a location of a warehouse associated with the first order, and one or more features of the warehouse.

4. The method of claim 1, further comprising:
comparing a current state of the picker in a process of completing the plurality of tasks at the predicted time increased by the threshold time with a predicted state of the picker at the predicted time; and
determining that picker did not complete the task at the predicted time increased by the threshold time, based on the comparison.

5. The method of claim 1, further comprising:
determining the threshold time based on a current location of the picker relative to a location of a warehouse associated with the first order.

6. The method of claim 1, further comprising:
determining the threshold time by applying a machine-learning algorithm on data associated with the picker.

7. The method of claim 1, further comprising:
determining that the intervention is a warning for the picker; and
responsive to the determination that the intervention is the warning, causing the device of the picker to display a warning message.

8. The method of claim 1, further comprising:
determining that the intervention is a removal of the picker from the first order; and
responsive to the determination that the intervention is the removal, causing the device of the picker to display a message informing the picker of being removed from the first order.

9. The method of claim 1, further comprising:
determining the intervention further based on at least one of: a progress of the picker in completing the plurality of tasks, an availability of one or more pickers associated with the online concierge system to accept the first order, and a predicted amount of time for another picker of a plurality of pickers associated with the online concierge system to accept the first order once the first order is made available to the plurality of pickers.

10. The method of claim 1, further comprising:
accessing a second computer model of the online concierge system trained to predict an effect of each candidate intervention of a plurality of candidate interventions on a completion of the plurality of tasks; and
applying the second computer model to determine the intervention from the plurality of candidate interventions.

11. The method of claim 10, wherein applying the second computer model comprises:
inputting, into the second computer model, information associated with at least one of the picker and a warehouse associated with the first order to determine the intervention from the plurality of candidate interventions.

12. The method of claim 11, wherein inputting the information into the second computer model comprises inputting at least one of: a location of the picker, one or more features of the picker, a location of the warehouse, and one or more features of the warehouse.

13. A computer program product comprising a non-transitory computer readable storage medium having instructions encoded thereon that, when executed by a processor, cause the processor to perform steps comprising:
receiving, from a user of an online concierge system, a first order placed with the online concierge system;
accessing a computer model of the online concierge system trained to predict a time for completion of each task associated with an order placed with the online concierge system;
applying the computer model to predict a plurality of times for completion of a plurality of tasks associated with the first order;
determining that a picker associated with the online concierge system who accepted the first order did not complete a task of the plurality of tasks at a predicted time of the plurality of times increased by a threshold time;
determining an intervention associated with the picker, based in part on the determination that the picker did not complete the task; and causing a device of the picker to display a message that corresponds to the determined intervention.

14. The computer program product of claim 13, wherein the instructions further cause the processor to perform steps comprising:
inputting, into the computer model, information associated with at least one of the picker and the first order to predict the plurality of times for completion of the plurality of tasks associated with the first order, and
the information input into the computer model comprise at least one of: a location of the picker, one or more features of the picker, a location of a warehouse associated with the first order, and one or more features of the warehouse.

15. The computer program product of claim 13, wherein the instructions further cause the processor to perform steps comprising:
comparing a current state of the picker in a process of completing the plurality of tasks at the predicted time increased by the threshold time with a predicted state of the picker at the predicted time; and
determining that picker did not complete the task at the predicted time increased by the threshold time, based on the comparison.

16. The computer program product of claim 13, wherein the instructions further cause the processor to perform steps comprising:
determining that the intervention is a warning for the picker; and
responsive to the determination that the intervention is the warning, causing the device of the picker to display a warning message.

17. The computer program product of claim 13, wherein the instructions further cause the processor to perform steps comprising:
determining that the intervention is a removal of the picker from the first order; and
responsive to the determination that the intervention is the removal, causing the device of the picker to display a message informing the picker of being removed from the first order.

18. The computer program product of claim 13, wherein the instructions further cause the processor to perform steps comprising:
accessing a second computer model of the online concierge system trained to predict an effect of each candidate intervention of a plurality of candidate interventions on a completion of the plurality of tasks;
applying the second computer model to determine the intervention from the plurality of candidate interventions.

19. The computer program product of claim 18, wherein the instructions further cause the processor to perform steps comprising:
inputting, into the second computer model, information associated with at least one of the picker and a warehouse associated with the first order to determine the intervention from the plurality of candidate interventions, and
the information input into the second computer model comprise at least one of: a location of the picker, one or more features of the picker, a location of the warehouse, and one or more features of the warehouse.

20. A computer system comprising:
a processor; and
a non-transitory computer-readable storage medium having instructions that, when executed by the processor, cause the computer system to perform steps comprising:
receiving, from a user of an online concierge system, a first order placed with the online concierge system;
accessing a computer model of the online concierge system trained to predict a time for completion of each task associated with an order placed with the online concierge system;
applying the computer model to predict a plurality of times for completion of a plurality of tasks associated with the first order;
determining that a picker associated with the online concierge system who accepted the first order did not complete a task of the plurality of tasks at a predicted time of the plurality of times increased by a threshold time;
determining an intervention associated with the picker, based in part on the determination that the picker did not complete the task; and
causing a device of the picker to display a message that corresponds to the determined intervention.
